(19) United States
(12) Patent Application Publication
(10) Pub. No.: US 2018/0141430 A1
(43) Pub. Date: May 24, 2018

(54) Drive Wheel

(71) Applicant: Siemens Aktiengesellschaft

(72) Inventors: Dirk Diehl, Bubenreuth (DE); Christian Eisele, Benshausen (DE); Gunter Freitag, Muenchen (DE); Lukas Heidrich, Ilmenau (DE); Markus Kloepzig, Ebermannstadt (DE); Kai Kriegel, Muenchen (DE); Klaus Schleicher, Nuernberg (DE)

(73) Assignee: Siemens Aktiengesellschaft, Muenchen (DE)

(21) Appl. No.: 15/316,306

(22) PCT Filed: May 28, 2015
(86) PCT No.: PCT/EP2015/061881

§ 371 Date: Dec. 6, 2016

(30) Foreign Application Priority Data
Jun. 3, 2014 (DE) 10 2014 210 416.5

(51) Int. Cl. B60K 7/00; F16D 65/12; F16D 55/22; F16D 65/84; B60B 21/02; B60B 21/10

(52) U.S. Cl. CPC B60K 7/0007; F16D 65/12; F16D 55/22; F16D 2065/138; B60B 21/026; B60B 21/104; F16D 65/84

(57) ABSTRACT

A drive wheel for a motor vehicle may include at least one sleeve-type wheel rim and an external-rotor motor that includes a rotor. The sleeve-type wheel rim may be connected directly and in a torque-coupled manner to the rotor using a releasable connection.

### CROSS-REFERENCE TO RELATED APPLICATIONS

This application is a U.S. National Stage Application of International Application No. PCT/EP2015/061881 filed May 28, 2015, which designates the United States of America, and claims priority to DE Application No. 10 2014 210 416.5 filed Jun. 3, 2014, the contents of which are hereby incorporated by reference in their entirety.

### TECHNICAL FIELD

The invention relates to a drive wheel for a motor vehicle.

### BACKGROUND

In the electric mobility sector, a multiplicity of drive concepts is being tested, and the usability thereof examined. By contrast to classic drive concepts, such as for example internal combustion engines, it is particularly advantageous, in particular in the case of electric motor vehicles, to integrate the drive motor directly into a drive wheel of the motor vehicle. The integration of the drive motor in the drive wheel is referred to as a wheel-hub drive.

An advantage of the wheel-hub drive is the omission of the classic drivetrain. It is thus possible, for example, for additional components such as friction brakes, power electronics elements, gearboxes and/or active damping systems to be integrated directly in the drive wheel, and thus in the wheel-hub drive.

According to the prior art, wheel suspension arrangements of classic drive concepts, in particular of drive concepts with internal combustion engines, are used for the formation of a wheel-hub drive. For example, the wheel rim of the drive wheel is typically screwed onto the drive motor of the wheel-hub drive axially from the outside. This leads to a reduction of the usable structural space within the drive wheel.

### SUMMARY

One embodiment provides a drive wheel for a motor vehicle, comprising at least one sleeve-shaped wheel-rim ring and an external-rotor motor with a rotor, wherein the sleeve-shaped wheel-rim ring is connected directly and in a torque-locking manner to the rotor by way of a detachable connection, wherein the drive wheel has no wheel-rim star and no wheel-rim disk.

In one embodiment, the external-rotor motor extends over almost the entire wheel-rim width of the sleeve-shaped wheel-rim ring.

In one embodiment, the sleeve-shaped wheel-rim ring is of unipartite form.

In one embodiment, a wheel-rim well of the sleeve-shaped wheel-rim ring is in the form of a flange, wherein the flange is connected directly and in torque-locking fashion to the rotor by way of the detachable connection.

In one embodiment, the drive wheel includes a perimeter brake which comprises a brake disk, wherein the brake disk is connected in non-positively locking fashion to the sleeve-shaped wheel-rim ring or to the rotor.

In one embodiment, the perimeter brake comprises a brake caliper which is connected to an axle of the drive wheel.

In one embodiment, the drive wheel includes a cooling device which is designed for cooling the perimeter brake, the brake disk and/or the brake caliper.

In one embodiment, the brake disk is connected in non-positively locking fashion to the sleeve-shaped wheel-rim ring or to the rotor by way of a brake web, wherein the brake web comprises at least one material which exhibits a high level of heat resistance.

In one embodiment, the drive wheel includes a seal plate or a bearing bracket, wherein a seal diameter of the seal plate or a bearing diameter of the bearing bracket are arranged on an axle of the drive wheel.

### BRIEF DESCRIPTION OF THE DRAWINGS

Example aspects and embodiments of the invention are described below with reference to the drawings, in which:

FIG. 1 is a schematic illustration of a drive wheel having an external-rotor motor, a sleeve-shaped wheel-rim ring and a perimeter brake, wherein a brake disk of the perimeter brake is connected in non-positively locking fashion to the wheel-rim ring; and

FIG. 2 is a schematic illustration of a drive wheel having an external-rotor motor, a sleeve-shaped wheel-rim ring and a perimeter brake, wherein a brake disk of the perimeter brake is connected in non-positively locking fashion to a rotor of the external-rotor motor.

### DETAILED DESCRIPTION

Embodiments of the present invention may increase the structural space within a drive wheel.

According to some embodiments, the wheel-rim ring of the drive wheel is fastened directly and in torque-locking fashion to the rotor of the external-rotor motor. According to some embodiments, it is possible in this way for a wheel-rim star and a wheel-rim disk of the drive wheel, such as are provided for example in the case of classic drive concepts, to be omitted. Through the omission of said components, it is advantageously the case that further structural space that was previously taken up by the wheel-rim star and the wheel-rim disk is used for the formation of a wheel-hub drive. Altogether, in this way, the structural space within the drive wheel is enlarged.

In other words, in the case of a two-part wheel rim, that is to say in the case of a wheel rim with a wheel-rim ring and a wheel-rim star, the wheel-rim star is replaced by the rotor of the external-rotor motor. For this purpose, the sleeve-shaped wheel-rim ring is fastened directly and in a torque-locking manner to the rotor of the external-rotor motor by way of a detachable connection. A detachable connection is advantageous because the wheel-rim ring can be exchanged without simultaneously exchanging the rotor of the external-rotor motor. In particular, a screw connection is provided for the connection or fastening of the wheel-rim ring to the rotor.

It may be advantageous if the external-rotor motor extends over almost the entire wheel-rim width of the sleeve-shaped wheel-rim ring. As used herein, “almost” may mean at least 90%.

In other words, almost the entire structural space within the wheel-rim ring is utilized for the external-rotor motor. In particular, the structural space for the external-rotor motor is not restricted or limited by a wheel-rim star and a wheel-rim disk of the drive wheel. Here, the additionally available structural space is used for the external-rotor motor or for further components of the wheel-hub drive, for example gearbox or electronics components.

A sleeve-shaped wheel-rim ring which is of unipartite form is particularly advantageous.

By way of the unipartite form of the sleeve-shaped wheel-rim ring, it is advantageously the case that connecting elements, which could lead to increased wear of the wheel-rim ring, are avoided. In this way, the reliability of the wheel-rim ring, and thus the reliability of the drive wheel as a whole, is improved.

In one embodiment of the invention, a wheel-rim well of the sleeve-shaped wheel-rim ring is in the form of a flange, wherein the flange is connected directly and in torque-locking fashion to the rotor by way of the detachable connection.

In other words, the sleeve-shaped wheel-rim ring is in the form of a drop-center wheel-rim ring (drop-center wheel rim). Here, the wheel-rim well of the drop-center wheel-rim ring is screwed in torque-locking fashion directly to the rotor of the external-rotor motor. In this way, it is advantageously made possible to realize a technically efficient and inexpensive drive wheel for a motor vehicle, in particular for an electric motor vehicle.

In one embodiment of the invention, a perimeter brake which comprises a brake disk is provided as a brake for the drive wheel, wherein the brake disk is connected or coupled in non-positively locking fashion to the sleeve-shaped wheel-rim ring or to the rotor.

It may be advantageously that, in this way, the structural space within the sleeve-shaped wheel-rim ring is not restricted, or is restricted only slightly, by the perimeter brake, such that said structural space can be utilized almost completely for the external-rotor motor and thus for the wheel-hub drive of the drive wheel.

In one embodiment of the invention, the perimeter brake comprises at least one brake caliper which is connected to an axle of the drive wheel.

In other words, the brake caliper of the perimeter brake is supported on the axle of the drive wheel, which axle is connected to the motor vehicle. Here, the perimeter brake or the brake caliper is arranged at the motor vehicle side.

It is for example possible for supply lines for the control and/or cooling of the perimeter brake and/or of the external-rotor motor to run through the axle, which is connected rotationally fixedly to the motor vehicle, of the drive wheel. Here, as an axle, a hollow axle may be provided, such that the supply lines for the drive wheel of the motor vehicle extend in protected fashion within the hollow axle.

For the cooling of the drive wheel, in particular of the perimeter brake and/or of the external-rotor motor, a cooling device is provided.

The cooling device may comprise cooling lines which directly cool the brake disk, the brake caliper, the rotor and/or stator windings of a stator of the external-rotor motor. In this way, it is advantageously possible for warming of the wheel-rim ring and/or of the rotor by the perimeter brake coupled to the wheel-rim ring or to the rotor, as a result of a braking process or as a result of a multiplicity of braking processes, to be avoided.

In one embodiment of the invention, the brake disk is connected in non-positively locking fashion to the sleeve-shaped wheel-rim ring or to the rotor by way of a brake web, wherein the brake web comprises at least one material which exhibits a high level of heat resistance. It is advantageously the case that, in this way, the perimeter brake which is fastened to the sleeve-shaped wheel-rim ring or to the rotor is thermally decoupled from the wheel-rim ring or from the rotor. In this way, it is additionally ensured that the wheel-rim ring or the rotor are not unduly warmed as a result of a braking process or a multiplicity of braking processes. In this way, bursting of a tire of the drive wheel, which tire is fastened to the drive wheel by way of the sleeve-shaped wheel-rim ring and is enclosed by the latter, is thus advantageously avoided.

In one embodiment of the invention, the drive wheel comprises a seal plate or a bearing bracket, wherein a seal diameter of the seal plate or a bearing diameter of the bearing bracket is arranged on an axle of the drive wheel.

In other words, the sealing of the drive wheel and/or of the external-rotor motor is realized at the smallest possible radial diameter. In this way, the path velocity at the location of the seal is advantageously reduced or minimized as far as possible, resulting in a lower friction torque. In this way, friction losses and wear of the seal are advantageously reduced.

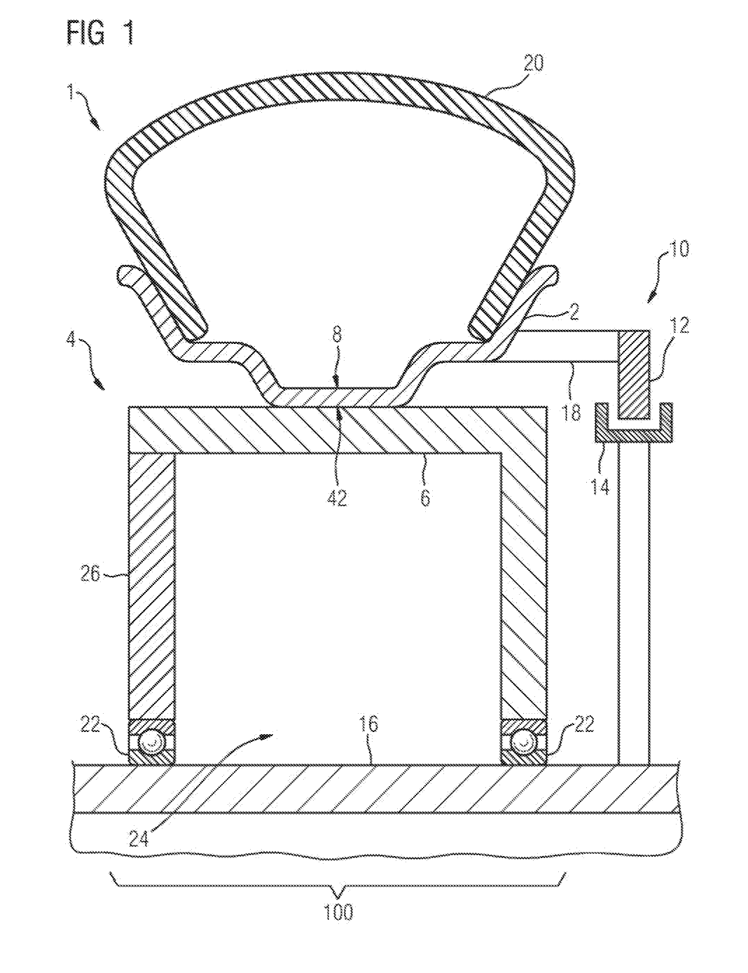

FIG. 1 is a schematic illustration of a drive wheel 1. Here, the drive wheel 1 comprises a sleeve-shaped wheel-rim ring 2 and an external-rotor motor 4, which external-rotor motor 4 comprises a rotor 6. The sleeve-shaped wheel-rim ring 2 is, according to the invention, connected directly and in torque-locking fashion to the rotor 6 of the external-rotor motor 4 by way of a detachable connection 42, in particular by way of a screw connection.

In other words, a torque which is generated by the external-rotor motor 4 is, by way of the detachable connection 42, transmitted via the rotor 6 to the sleeve-shaped wheel-rim ring 2 which is directly fastened to the rotor 6.

The wheel-rim ring 2 is in the form of a drop-center wheel-rim ring, wherein a wheel-rim well 8 of the drop-center wheel-rim ring forms a flange which is connected by way of the detachable connection 42 to the rotor 6.

The rotor 6 of the external-rotor motor 4 is supported by way of bearings 22 on an axle 16, which is connected to a motor vehicle—motor vehicle not illustrated—of the drive wheel 1. Here, a seal plate 26 or a bearing bracket 26, which is supported on the axle 16 by way of a further bearing 22, may be provided on that side of the drive wheel 1 which is averted from the motor vehicle.

The seal plate 26 or the bearing bracket 26 may be connected to the rotor 6.

The rotor 6 of the external-rotor motor 4 delimits, within the wheel-rim ring 2, a structural space 24 whose axial length extends over approximately the entire wheel-rim width 100 of the wheel-rim ring 2. Here, the axial length is to be understood to mean the length in an axial direction, that is to say parallel to the axis 16. The invention thus has the advantage over the prior art that the structural space 24 is not delimited axially by a wheel-rim star and/or a wheel disk, whereby the structural space 24 is enlarged in relation to the prior art. The enlarged structural space 24 in relation to the prior art may be used for further components of the external-rotor motor 4, for example for a stator, electronics components and/or a gearbox.

In the exemplary embodiment of the invention illustrated in FIG. 1, a perimeter brake 10 is arranged at the motor vehicle side. Here, the perimeter brake 10 comprises a brake disk 12, which is connected or coupled in non-positively locking fashion to the wheel-rim ring 2 by way of a brake web 18. Here, for the brake web 18, a material is provided which exhibits a high level of heat resistance. The brake disk 12 of the perimeter brake 10 is enclosed by a brake caliper 14 of the perimeter brake 10, wherein the brake caliper 14 is supported by way of a further element on the axle 16 of the drive wheel 1. Furthermore, cooling devices and/or cooling lines (not illustrated) may be provided for the perimeter brake 10 and/or for the rotor 6 of the external-rotor motor 4, such that, in the event of a braking process or a multiplicity of braking processes, bursting of a tire 20, which tire 20 is arranged on and enclosed by the wheel-rim ring 2, does not occur.

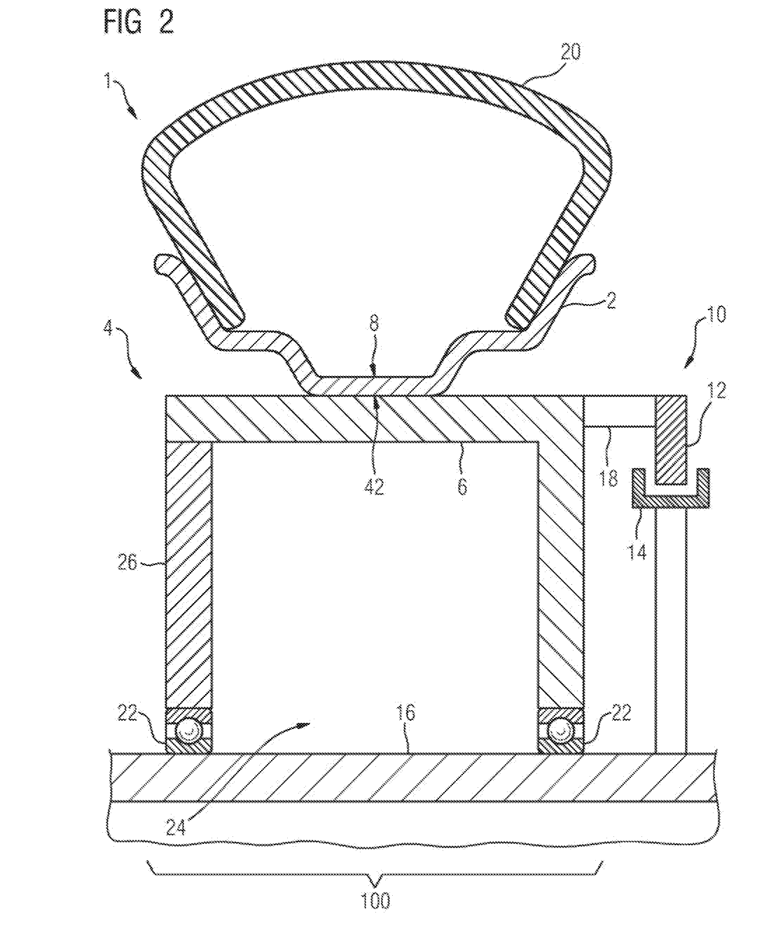

Supply lines for the drive wheel 1, for example electronic control lines and/or cooling lines, run in this case within the axle 16 of the drive wheel 1, wherein, for this purpose, the axle 16 is expediently in the form of a hollow axle. In this way, the supply lines are advantageously encased by the axle 16 and are consequently arranged in protected fashion. FIG. 2 is a schematic illustration of a drive wheel 1, wherein, by contrast to FIG. 1, a perimeter brake 10 is arranged on a rotor 6 of an external-rotor motor 4. Here, FIG. 2 shows the same elements as have already been shown in FIG. 1.

The perimeter brake 10 comprises a brake disk 12 which is connected by way of a brake web 18 to the rotor 6 of the external-rotor motor 4. Here, the brake disk 12 is in turn enclosed by a brake caliper 14 of the perimeter brake 10, wherein the brake caliper 14 is supported on an axle 16 of the drive wheel 1. In other words, in the exemplary embodiment of the invention illustrated in FIG. 2, a braking action of the perimeter brake 10 arises directly as a result of a slowing of the rotor 6 of the external-rotor motor 4. Here, as is already the case in FIG. 1, further components, for example a cooling device and cooling lines for the perimeter brake 10 or the rotor 6, may be provided.

The perimeter brake 10 is expediently arranged at the motor vehicle side, such that a structural space 24 extends over almost the entire wheel-rim width 100 of a wheel-rim ring 2. The structural space 24 may be used for the external-rotor motor 4 and/or for further components of the drive wheel 1.

By way of the detachable connection 42 according to the invention of the sleeve-shaped wheel-rim ring 4 to the rotor 6 of the external-rotor motor 4, almost the entire structural space (structural space 24) available within the wheel-rim ring 2 can be utilized.

Even though the invention has been illustrated and described in more detail by way of the preferred exemplary embodiments, the invention is not restricted by the disclosed examples, or other variations may be derived from these by a person skilled in the art without departing from the scope of protection of the invention.

What is claimed is:

1. A drive wheel for a motor vehicle, the drive wheel comprising:
at least one sleeve-shaped wheel-rim ring, and
an external-rotor motor with a rotor,
wherein the sleeve-shaped wheel-rim ring is connected directly and in a torque-locking manner to the rotor by a detachable connection, and
wherein the drive wheel has no wheel-rim star and no wheel-rim disk.

2. The drive wheel of claim 1, wherein the external-rotor motor extends over almost an entire wheel-rim width of the sleeve-shaped wheel-rim ring.

3. The drive wheel of claim 1, wherein the sleeve-shaped wheel-rim ring has a unipartite form.

4. The drive wheel of claim 1, wherein a wheel-rim well of the sleeve-shaped wheel-rim ring comprises a flange, wherein the flange is connected directly and in torque-locking manner to the rotor by the detachable connection.

5. The drive wheel of claim 1, including a perimeter brake comprising a brake disk, wherein the brake disk is connected in non-positively locking manner to the sleeve-shaped wheel-rim ring or to the rotor.

6. The drive wheel of claim 5, wherein the perimeter brake comprises a brake caliper that is connected to an axle of the drive wheel.

7. The drive wheel of claim 5, including a cooling device configured to cool at least one of the perimeter brake, the brake disk, or the brake caliper.

8. The drive wheel of claim 5, wherein the brake disk is connected in a non-positively locking manner to the sleeve shaped wheel-rim ring or to the rotor by a brake web,
wherein the brake web comprises at least one heat-resistant material.

9. The drive wheel of claim 1, including a seal plate or a bearing bracket, wherein a seal diameter of the seal plate or a bearing diameter of the bearing bracket is arranged on an axle of the drive wheel.

10. A motor vehicle, comprising:
a drive wheel comprising:
at least one sleeve-shaped wheel-rim ring, and
an external-rotor motor with a rotor,
wherein the sleeve-shaped wheel-rim ring is connected directly and in a torque-locking manner to the rotor by a detachable connection, and
wherein the drive wheel has no wheel-rim star and no wheel-rim disk.
